(19) United States
(12) Patent Application Publication
(10) Pub. No.: US 2005/0108090 A1
(43) Pub. Date: May 19, 2005

(54) Service points liquidation system

(76) Inventors: Yutaka Takeda, Fukui (JP); Tsunemasa Hayashida, Fukui (JP); Kazuya Takeda, Tokyo (JP)

Correspondence Address: Ronald R Snider, PO Box 27613, Washington, DC, 20038-7613, US

(21) Appl. No.: 10/489,405

(22) PCT Filed: Nov. 13, 2003
(86) PCT No.: PCT/JP03/14483

(51) Int. Cl. G06F 17/60

(52) U.S. Cl. 705/14

(57) ABSTRACT

Service points liquidation system is provided, wherein a service point is provided to the customers and the accumulated service points are liquidated so as to stimulate their propensity to further consumption.

This liquidation system comprises a conversion means 1 to convert an amount paid or the number of applications made by a customer into a service point and a host computer 2 in which the service points data are stored, which computer is provided with a database construction means 21, a storage means 22, a reference means 23 and a liquidation processing means 24, wherein the accumulated service points data arranged for each customer as individual accumulated service points databases by the database construction means 21 are subjected to the liquidation processing means 24 so as to be stored in the storage means 22.

### TECHNICAL FIELD

The invention relates to a system for rendering a service to customers, in more details, pertaining to a service points liquidation system wherein incentive service points are given to the customers according to the amount paid or the number of applications made, which points as accumulated are liquidated so as to stimulate the customers' propensity to further consumption.

### BACKGROUND ART

As a method to guide the human's capricious behaviors to a certain direction, such methods as induced by profit, legal enforcement, tricking or cheating actions or terror are known, the legal enforcement among which is executed only by a nation or its public offices and organizations and the civilian enterprises are unable to perform. Such methods as putting the people into confusion by tricky actions or subliminally influencing on the public or guiding the peoples' behaviors to a certain direction by terror are not allowable in light of keeping the society in safety and order. The sole method adoptable to the civilian enterprises for the purpose of guiding the peoples' behaviors is through an incentive for making profit, provided, however, that the people are guided in good faith.

However, even though the people are guided in good faith, such simple method as giving incentives such as allowances for a specific action to the sound contemporary adults whose education level is so high gives no effect to them. This is because the humans are motivated not only by the money, but also by the mental satisfaction brought by the actions taken. The people strive for reaching a target, upon the realization of which target the process to achieve the same gives true satisfaction to them.

For instances, in order to enhance the attraction of the customers, it is widely adopted among the retailers' shops and at the shopping centers that seals are given to their customers or stamps are put on their incentive cards according to the amount of payment, according to the number of which seals or stamps as accumulated they receive a money's worth of a certain value.

However, those incentive cards are handed over to their customers by the respective retailers' shops, which tends to make their purses messy and crowded. Moreover, rendering of an incentive service under such standardized conditions as mentioned above is taken by the customers just as a partial return of the amount paid or the posterior markdown of the price of which they are charged. This does not arouse their interest in further consumption, as lacking a sense of entertainment on the part of the customers.

Further, it is anticipated that the sales of such speculative games as horseracing, bicycle-racing, motorboat-racing and motorbike-racing and the sales of the lottery tickets under the sponsorship of the local municipalities are promoted, one portion of which profit is appropriated as a public revenue. Such entertainment as above provides a casual pastime to the players in which they anticipate receiving a payback as a result of their votes being found winners or hitting the jackpot. To our disappointment, once the results being announced, the voting or lottery tickets found losers are scattered around the meeting places or on the street. In the above circumstances, such device is disclosed in the Japanese Patent Application Laid-open No.2001-52094 as collecting the voting or lottery tickets found losers and granting a service point to the losers as collected. The subject matter of the above prior art is to grant a service point to the voting or lottery tickets found losers so as to add value to those useless tickets. However, just accumulating the service points does not excite the players so much with the expectation of a mishap in contingency, thus, such corrective measures as effectively contributing to the sales increase thereof are highly anticipated.

That is to say, it is anticipated that consumption activities are soundly promoted with the motivations on the part of the players to accumulate the points granted to the voting or lottery tickets found losers so as to win a prize while the players are satisfied with the prize as awarded and hopefully the market as a whole is activated with improved consumption synergistically induced among various business sectors.

### DISCLOSURE OF THE INVENTION

In view of the above inconveniences encountered with the prior art, the present invention is to provide a service points liquidation system wherein a service point is given to a customer in exchange for consumption and the points as accumulated are liquidated so as to stimulate the customers' propensity to consumption. Further, the present invention is to provide such system as mentioned above wherein the customers' interest is further aroused and enhanced without a sense of emptiness even if the voting or lottery tickets they have are found losers. The means to solve the above issues are described below with reference to the accompanying drawings. That is to say, the technical means adopted in the invention is characterized in comprising a conversion means 1 to convert either an amount paid or the number of applications made by a customer into a service point and a host computer 2 in which the service point data are stored, wherein the host computer 2 is provided with a database construction means 21, a storage means 22, a reference means 23 and a liquidation processing means 24, by way of which database construction means 21 the service point data of the whole customers are arranged for each of them so as to be stored in the storage means 22 as individual accumulated service points databases, on the basis of which databases as stored in the storage means 22 the accumulated service points data and the corresponding ordinal position of each customer are searchable through the reference means 23, through which liquidation processing means 24 larger accumulated service points data lined up to an ordinal position ‘n’ are extracted from the individual accumulated service points databases and an amount of the accumulated service points corresponding to the ordinal position ‘n’ is defined as a liquidation point P, a consideration V according to which liquidation point P is given to higher-ranked customers lined up to the ordinal position ‘n’ so as to liquidate their accumulated service points, in which the accumulated service points of each customer less than the liquidation point P are carried over to the next term while the accumulated service points of each customer beyond the liquidation point P being carried over to the next term with the liquidation point P deducted from the accumulated service points so as to be stored in the storage means 22. In addition to the above technical means to solve the above issues, the invention is characterized in adopting a technical means wherein an amount of payment agreed upon in a commercial transaction executed on an internet homepage is converted into a service point by the conversion means 1, the data on which service point are stored in the storage means 22. In addition to the above, the invention is characterized in adopting a technical means wherein a bus/taxi fare or a face value of a boarding ticket for traveling by such transportation means as air/ship/train and/or a traveled mileage is converted into a service point by the conversion means 1, the data on which service point are stored in the storage means 22. Then, in order to solve the above issues in respect of the votes cast for playing speculative games that are found losers, the additional technical means adoptable to the above are as follows.

It is arranged herein that the number of votes applied for or a amount paid to buy the votes by a customer in a speculative game that are found losers is converted into a service point by the conversion means 1, the data on which service point are stored in the storage means 22.

It is arranged herein that a voting ticket discerning device 3 is provided to receive a magnetic voting ticket that a customer applies for, which device is provided with a discerning means 31 to check if the magnetic voting ticket is a winner or not and a disposal means 32 to collect and dispose of the voting ticket found a loser, wherein the votes cast in the voting ticket and found losers are converted into a service point by the conversion means 1 so as to be transmitted to the host computer 2.

It is arranged herein that the voting ticket is returned with only the votes found losers processed when the votes found winners are included in the voting ticket received in the voting ticket discerning device 3.

It is arranged herein that the data on the votes cast by a customer through an electronic communication line to a host server and so forth and found losers are transmittable to the host computer 2.

Then, in order to solve the above issues in respect of the lottery tickets found losers, the additional technical means adoptable in the invention are as follows.

It is arranged herein that the number of applications made or an amount paid by a customer for buying a tickets-enveloped lottery, a sealed lottery, a numbers choice lottery or a sports game result guessing lottery and as such that is found a loser is converted into a service point by the conversion means 1, the data on which service point are stored in the storage means 22 of the host computer 2.

It is arranged herein that a service point is provided according to an amount paid or the number of applications made for buying a lottery that is found a loser after the expiration of the effective term for money-exchange.

It is arranged herein that a lottery ticket discerning device 4 to receive a lottery ticket therein is provided, which device is provided with a discerning means 41 to check whether the lottery ticket is a winner or not and a disposal means 42 to collect and dispose of the lottery ticket found a loser, wherein the number of applications or an amount paid for buying the lottery ticket found a loser is converted into a service point by the conversion means 1 so as to be transmitted to the host computer 2.

The additional technical means to the above for a user's convenience' sake are as follows.

It is arranged herein that a service point is read out of and written in a data carrier D that each customer carries by means of a reader/writer 5, and the service point data and an ID data on each customer are transmitted to the host computer 2 through the reader/writer 5.

It is arranged herein that the host computer 2 is provided with a data input means 25 to renew, rewrite and input the service point data as stored in the storage means 22.

It is arranged herein that the host computer 2 is provided with a buffer storage 26 to enhance data processing speed.

It is arranged herein that the data on the specific ordinal position ‘m’ are extracted from the individual accumulated service points databases as stored in the storage means 22 by way of a liquidation processing means 24 and a prize is given to a customer ranked in the specific ordinal position ‘m’.

It is arranged herein that a plurality of host computers 2•2•• are connected to a governing server so that the service points are exchangeable among those computers.

It is arranged herein that the host computer 2 is connected to an internet server so that the accumulated service points data and corresponding ordinal position of each customer are searchable on an internet homepage.

It is arranged herein that the use of such portable data communication devices as a cellular phone enables the accumulated service points data and corresponding ordinal position of each customer as stored in the storage means 22 to be searched through a voice recording and push signals.

It is arranged herein that only the data on a searcher and higher-ranked customers are searchable from the individual accumulated service points databases.

It is arranged herein that the data on the accumulated service points data and corresponding ordinal position of each customer are electronically and automatically mailed on a periodical or non-periodical basis to a customer address as preliminarily registered.

It is arranged herein that a customer whose accumulated service points are subjected to liquidation is also registered in a host computer 2 defined as a one-rank superior system.

### BRIEF DESCRIPTION OF THE DRAWINGS

FIG. 1 is an explanatory view to show the system operation according to the first embodiment hereof;

FIG. 2 is a flow chart to show the system operation according to the first embodiment hereof;

FIG. 3 is an explanatory view to show one example of the liquidation process according to the first embodiment hereof;

FIG. 4 is an explanatory view to show the system operation according to the second embodiment hereof;

FIG. 5 is a flow chart to show the system operation according to the second embodiment hereof;

FIG. 6 is an explanatory view to show the system operation according to the third embodiment hereof; and

FIG. 7 is a flow chart to show the system operation according to the third embodiment hereof.

### BEST MODE FOR CARRYING OUT THE INVENTION

Hereafter, the preferred embodiments for carrying out the invention are in more details described with reference to the accompanying drawings.

### First Embodiment

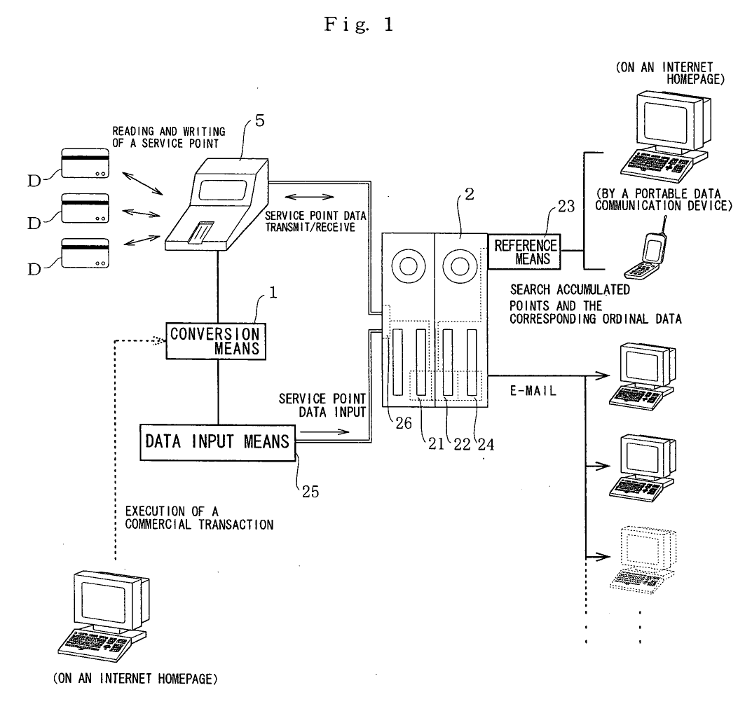

The first embodiment hereof is explained with reference to FIG. 1 through FIG. 3, in which reference numeral 1 indicates a conversion means, which means is intended for converting an amount paid by a customer into a service point.

Reference numeral 2 in the drawings indicates a host computer, which computer is capable of storing the data on the service point and is provided with a database construction means 21, a storage means 22, a reference means 23, a liquidation processing means 24, a data input means 25 and a buffer storage 26.

To note, in the operation system hereof, a reader/writer indicated with reference numeral 5 in FIG. 1 may be adopted, which is intended for reading the service point out of and writing the same in a data carrier D such as a magnetic card and an IC chip integrated card that each customer carries. An ID card operated under the network system of the Principal Register of the Japanese Nationals may be adopted for the data carrier D. In addition to the feature that the service point is read out of and written in the data carrier D hereof that each customer carries by way of the reader/writer 5, the data on the service point and an ID data on each customer are transmitted to the host computer 2 by way of the reader/writer 5.

(Example of System Operation)

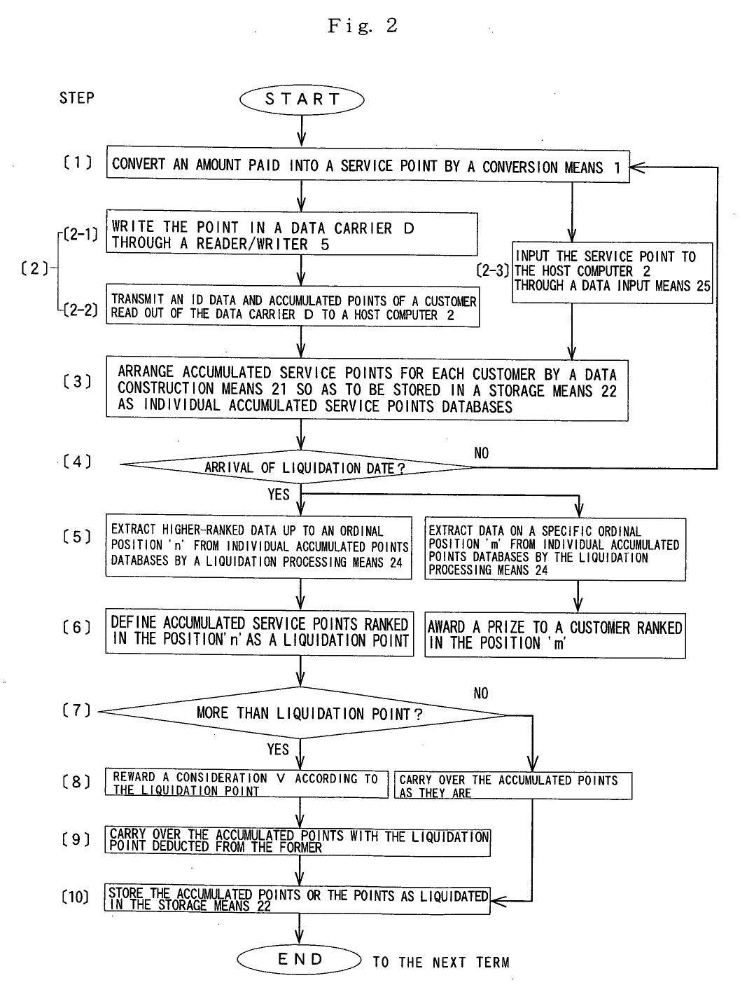

Hereafter, the system operation according to the present embodiment is described step by step on the basis of the flow chart shown in FIG. 2.

To begin with, at Step (1), a customer paying an amount, the amount paid is converted into a service point by a conversion means 1. For instance, the payment amounting to 100 Yen is converted into one service point. In this case, a fare to pay for getting on a bus or in a taxi or a face value of a boarding ticket on such transportation means as air/ship/train and/or the traveled mileage thereof may be converted into the corresponding service point.

Alternatively, an amount of payment agreed upon in a commercial transaction executed on an internet homepage may be converted into the corresponding service point.

Then, at Step (2-1), the service point is written in the data carrier D that each customer carries by means of the reader/writer 5, and the data on each customer (name, address and so forth) and the corresponding accumulated service points are transmitted to the host computer 2 at Step(2-2) or the service points data are input through the data input means 25 to the host computer 2 at Step (2-3) so as to be stored in the storage means 22 at Step (3), in which storage means 22 the service points data of the whole customers arranged individually by way of the database construction means 21 are stored as individual accumulated service points databases. The arrangement of the service points data as mentioned above is principally intended for ranking individual accumulated service points, in addition to which it may be arranged such that the dates when and the points of contact where the data on each customer are received and a service point is added on are docketed.

In this way, while the service points are accumulated one after another according to an amount paid by each customer until the liquidation date comes, higher-ranked data lined up to an ordinal position ‘n’ are extracted from the accumulated service points databases at Step (5) by the liquidation processing means 24 when the liquidation date arrives at Step (4). Herein, the ordinal position ‘n’ is defined as the 50^{th} so that the top fifty customers are extracted.

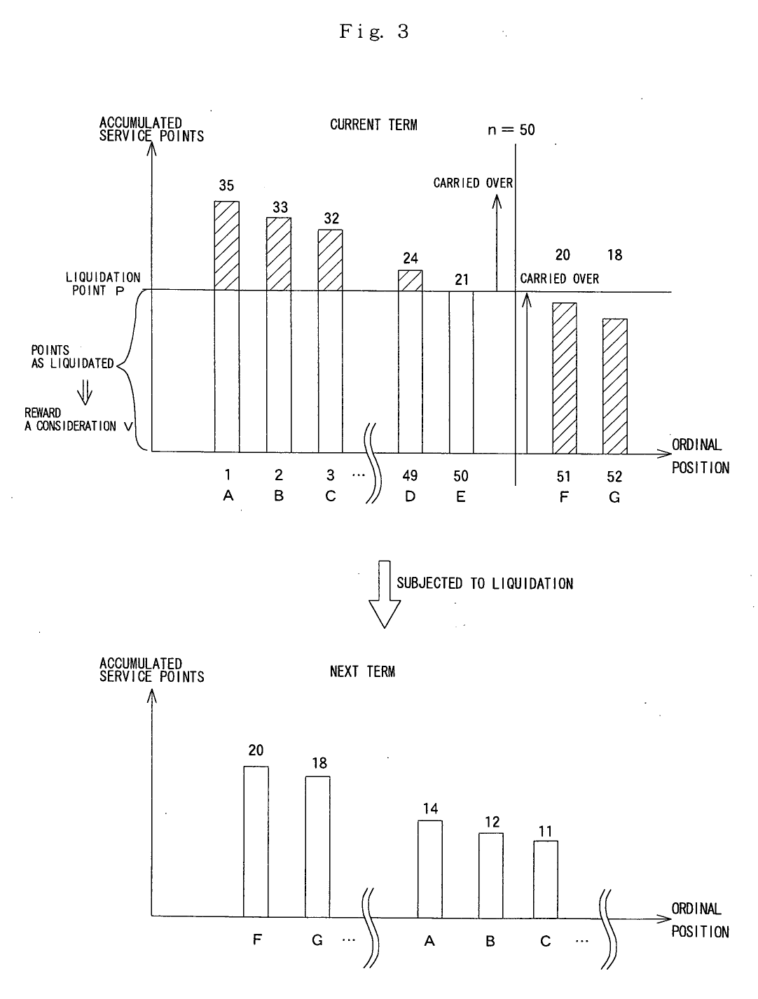

Hereupon, the accumulated service points corresponding to the ordinal position ‘n’ provide a liquidation point P at Step (6). As shown in FIG. 3, assuming that the first ranked customer has 35 accumulated service points (35p) and the 49^{th}, the 50^{th} and the 51st ranked customers have 24, 21 and 20 accumulated service points (24p), (21p) and (20p) respectively and under the prescribed condition that the ordinal position ‘n’ is equivalent to the 50^{th}, the liquidation point P is defined as (21p). This liquidation point P is indefinitely provided with the ordinal position ‘n’ changed, so that the liquidation point P for the next term does not become necessarily the same as the current term.

Further, at Step (6), it may be arranged such that the service points data corresponding to a specific ordinal position ‘m’ is extracted from the accumulated service points databases through the liquidation processing means 24 and a prize is given to a customer ranked at the specific ordinal position ‘m’. For instances, such conspicuously recognized numbers as 100^{th} and 777^{th} may be defined as the specific ordinal position ‘m’ so that each customer continues to feel excited about winning a prize even though he/she is not ranked in a higher position so as to be more satisfied with participation in the liquidation system as described above.

Then, at Step (7), the accumulated service points of the respective customers ranked up to the ordinal position ‘n’ are subjected to liquidation at the current term, and a consideration V is given to them according to the liquidation point P, which consideration V may be a money-exchangeable ticket or a money's worth. On the other hand, the accumulated service points of the remaining customers respectively not reaching the liquidation point P so as not to be subjected to liquidation at the current term are carried over to the next term at Step (8).

The accumulated service points of the higher-ranked customers respectively subjected to liquidation at the current term are carried over to the next term with the liquidation point P deducted from the service points accumulated up to the current term at Step (9). Then, the accumulated service points of each customer as liquidated above are stored in the storage means 22 of the host computer 2 for starting the next term at Step (10).

Hereupon, where appropriate, the host computer may be provided with a buffer storage 26 to enhance the data processing speed to promptly cope with large volume of data as received therein.

Arranging the system operation according to the present embodiment such that the data stored in the storage means 22 of the host computer 2 are referred to by the reference means 23 so as to enable the customers who aim at being qualified to liquidate their service points accumulated up to the current term for the purpose of winning a prize to search their accumulated service points and the corresponding ordinal positions gives effect to further promote consumption on their part.

### Second Embodiment

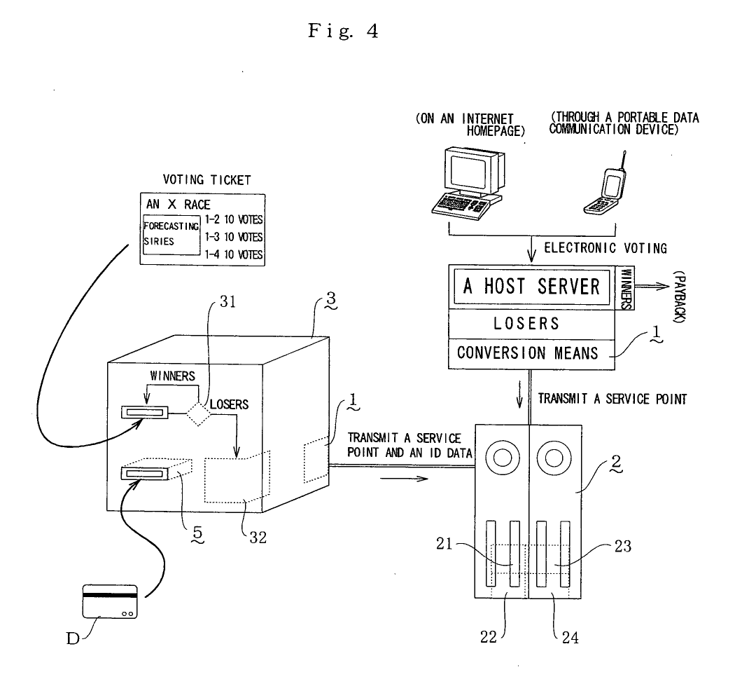

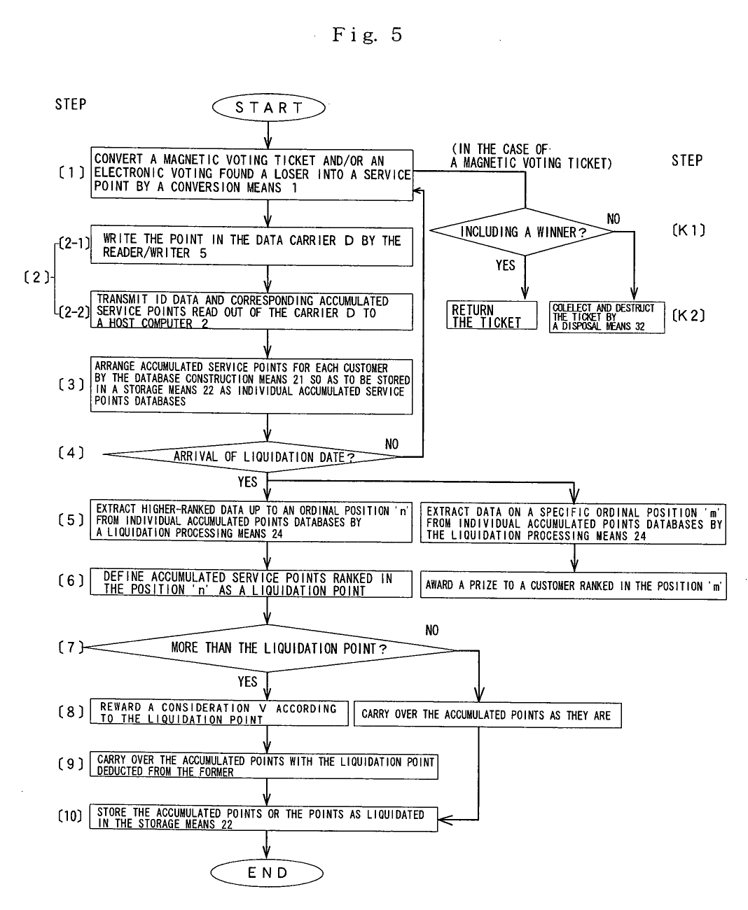

Then, the second embodiment hereof is described below on the basis of FIG. 4 and FIG. 5. Herein, the conversion means 1 is intended for converting a vote found a loser into a service point.

In the drawings, reference numeral 3 indicates a voting ticket discerning device, which device is provided with a discerning means 31 to receive therein a magnetic voting ticket through which a customer casts a vote and check whether the voting ticket is a winner or not and a disposal means 32 to collect and dispose of the voting ticket when the vote cast through the voting ticket and received in the discerning means 31 turns out to be found a loser. The vote cast through the voting ticket and found a loser is converted into a service point by the conversion means 1 so as to be transmitted to the host computer 2.

To note, in recent years, voting methods have been diversified, which include a telephone voting and an internet voting for examples to enable a customer living in areas remote from a race-meeting place or an out-of-the-spot ticket vending window to cast a vote, so that it may be arranged such that the data on a vote cast through an on-line electronic voting to a host server and turned out to be found a loser are transmitted to the host computer 2.

(Example of System Operation)

The system operation according to the present embodiment is described step by step on the basis of the flow chart shown in FIG. 5. Principally, at Step (1), among the whole votes cast by a customer, a vote turned out to be found a loser after the game result has become definitive is converted into a service point through the conversion means 1. For example, ten votes found losers corresponding to 100 Yen, provided that one vote amounts to 10 Yen, are converted into one service point. Hereupon, the voting method may be a telephone voting or an internet on-line voting, besides through a magnetic voting ticket sold at an on-the-spot ticket window.

Derivatively, when a customer casts votes through a magnetic voting ticket, the voting ticket is received in the voting ticket discerning device 3 so as to be checked whether the voting ticket is a winner or not by the discerning means 31 at Step (K-1). Then, when the voting ticket received therein turns out to be found a loser, the voting ticket is collected and disposed of by the disposal means 32 such as a collection box or a shredder. Hereupon, the destruction of the voting ticket found a loser by a shredder into smithereens prevents the invalid voting ticket from being reused unjustly.

On the other hand, when the voting ticket includes valid votes, the voting ticket is returned with only the invalid votes processed at Step (K-2) and the effective votes are subjected to a payback procedure in a prescribed manner.

As for the subsequent Step (3) through Step (10), they are processed in the same way as those of the foregoing first embodiment.

### Third Embodiment

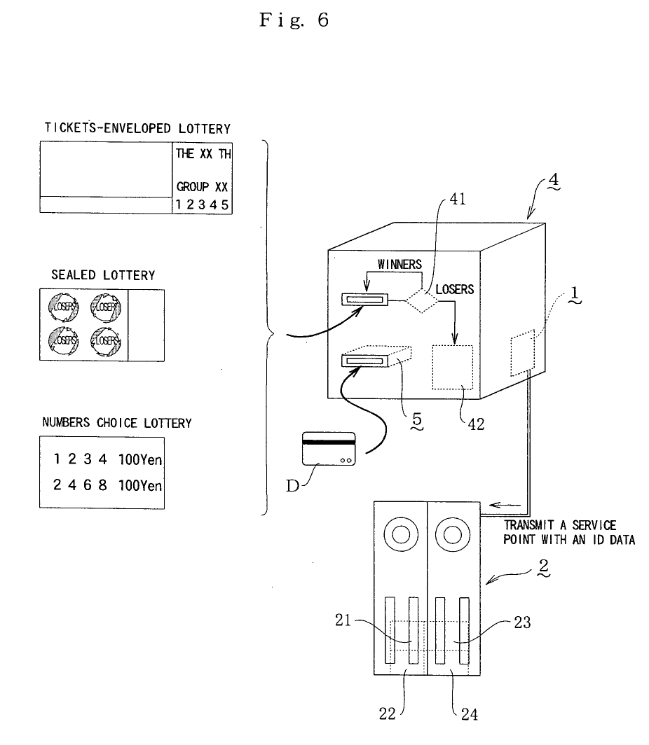

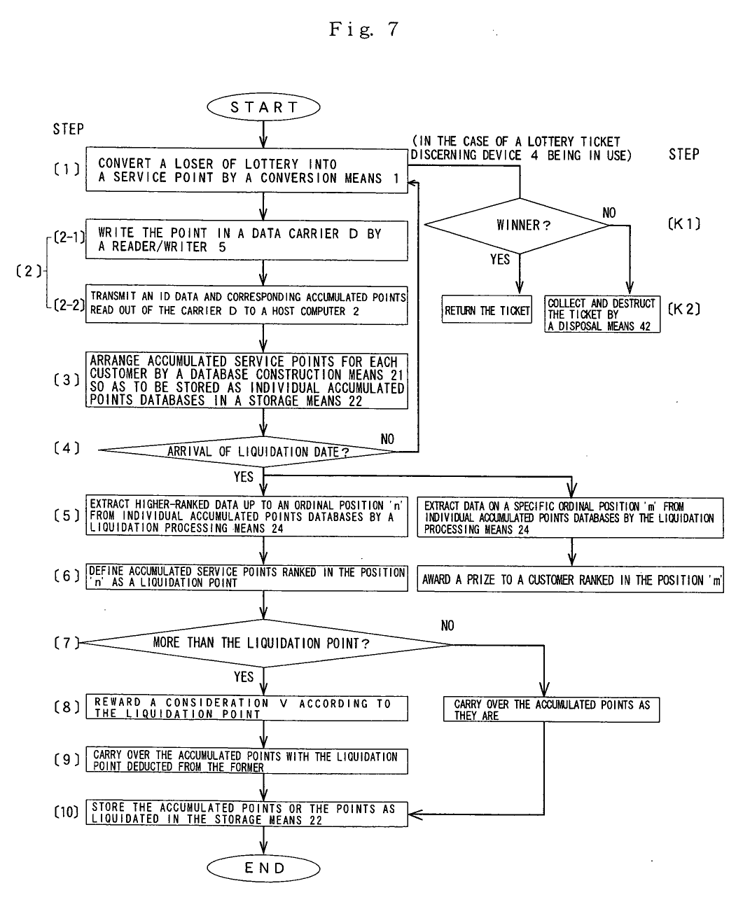

The third embodiment hereof is described below on the basis of FIG. 6 and FIG. 7. Herein, the conversion means 1 is intended for converting the number of applications for lottery or a face value of a lottery ticket resulting in a loser into a service point.

In the drawings, reference numeral 4 indicates a lottery ticket discerning device to receive therein a lottery ticket, which device is provided with a discerning means 41 to check whether the lottery ticket is a winner or not and a disposal means 42 to collect and dispose of the lottery ticket turned out to be found a loser. The number of applications for lottery or a face value of a lottery ticket found a loser is converted into a service point by the conversion means 1 so as to be transmitted to the host computer 2.

(Example of System Operation)

The system operation according to the present embodiment is described step by step on the basis of the flow chart shown in FIG. 7.

In principle, among the lottery tickets purchased by a customer, a lottery ticket found a loser is converted into a service point at Step (1) through the conversion means 1. For instance, a lottery ticket whose face value amounts to 100 Yen and that turns out to be found a loser is converted into one service point.

Derivatively, at Step (K-1), a lottery ticket is received in the lottery ticket discerning device 4 so as to be checked whether it is a winner or not through the discerning means 41. Then, when the lottery ticket is found a loser, it is collected and destructed by the disposal means 42 such as a collection box or a shredder. Hereupon, its destruction by means of a shredder prevents the loser from being reused unjustly.

On the other hand, when the lottery ticket is found a winner, it is returned at Step (K-2) and subjected to payback procedure in a prescribed manner.

The subsequent Step 3 through Step 10 is processed in the same way as those of the foregoing first and second embodiments.

(Modified Examples of System Operation)

The system operation according to the above first through third embodiments is modifiable as follows. For instances, the host computer 2 is connected to an internet server so as to enable a customer to search his/her accumulated service points and corresponding ordinal position on homepage, in other words, which information is accessible from a domestic personal computer terminal in a casual manner. Further, the use of such portable data communication devices as a cellular phone enables a customer to search his/her accumulated service points and corresponding ordinal position as stored in the storage means 22 through voice recording or push signals so as to be able to promptly obtain up-to-date information.

Further, it may be arranged such that a service point is provided according to a face value of a lottery or voting ticket found a winner or the number of applications for lottery or votes found winners after the expiration of the effective term for money-exchange. Furthermore, the data on the accumulated service points and corresponding ordinal position of each customer may be electronically mailed to an address preliminarily registered on a periodical or non-periodical basis, which allows them to keep watch on their ordinal positions as well as a service provider to transmit advertisement and events information to the customers.

Moreover, the mutual exchangeability of the service points among the plurality of the host computers 2 that are connected to a governing server allows the system operation to be scaled up, which well copes with such cases as the plurality of business entities undertaking a joint venture or the sales service points issued from such shopping facility as department stores, supermarkets and convenience stores being combined with the service points provided under the operation of the liquidation system hereof. That is to say, a large-scale deployment is possible with the liquidation system hereof being operated in exchange with different business sectors or in alliance with various industry and commerce organizations or economic federations. Further, a certain service point may be prescribed for various volunteer activities under the sponsorship of the autonomous bodies, which service point may be associated with the service points operated under the other systems including the liquidation system hereof for joint operation.

Further, it may be arranged such that the data on only a searcher himself/herself or the higher-ranked customers are searchable, in which the privacy of the other customers is protected with their names undisclosed. Likewise, the awareness of his/her ordinal position relative to others allows a customer belonging to a higher-ranked group positioned to be almost qualified for liquidation to choose whether his/her accumulated service points are liquidated at the current term or the next term. Hereupon, for example, the modification of a prize to be rewarded to the customers such as a money's worth and a money-exchangeable ticket at each term increase enjoyment on the part of the customers.

In addition to the above, the higher-ranked customers whose accumulated service points are liquidated at the current term may be also registered in a host computer 2 defined as an one-rank superior system, in which case their accumulated service points as liquidated at the current term are carried over to the next term within the previous liquidation system while they also belong to the one-rank superior system. This superior system may be arranged in the same way as the previous liquidation system, but making such contents as a value of a money's worth and an exchange condition of the liquidation point to a money-exchangeable ticket better motivates the customers to reach a higher liquidation system, which leads to the increase of the sales or profit on the part of the sponsors or organizers.

The invention is substantially arranged as described above, but it should be appreciated that it is not limited to the embodiments shown in the accompanying drawings, but can be modified in various manners within the scope of the accompanying patent claims. For examples, the conversion rate by means of the conversion means 1 of a service point to an amount paid or the number of applications made by a customer may be defined in an arbitral manner. Further, the higher-ranked customers lined up to an ordinal position ‘n’ as extracted from individual accumulated service points databases are not limited to 50 nominees, which ordinal position may well correspond to another number of nominees or several percentage of higher-ranked nominees of the whole customers. Those modifications also belong to the technical scope of the invention.

### Industrial Applicability

According to the service points liquidation system hereof, an amount paid or the number of applications made by each customer is converted into a service point by the conversion means, which point is accumulated so that the accumulated service points of higher-ranked customers exclusively are subjected to liquidation so as to reward a consideration to them according to a liquidation point for the reimbursement of the profit gain to the customers, which stimulates their propensity to further consumption and leads to the activation of the shopping districts of local areas among others.

Further, where the votes cast for speculative games and the lottery tickets are found losers, the customers are further aroused their interest in participating in them without a sense of emptiness, which leads to the increased revenue especially of the autonomous bodies.

Moreover, the liquidation system hereof is inexpensive in equipment and operation cost and operable with facility, so that the consolidated operation of the system in a large scale by the shopping districts or the shopping centers or the municipalities might activate the commercial market as a whole.

Where appropriate, the adoption of an ID card operated under the network system of the Principal Register of the Japanese Nationals or a credit card used for an on-line settlement and so forth for the data carrier hereof greatly contributes to the formation of a ubiquitous society where information network system is highly developed for easy access.

1. Service points liquidation system comprising a conversion means 1 to convert one of an amount paid and number of applications made by a customer into a service point and a host computer 2 in which data on said service point are stored, wherein said host computer 2 is provided with a data base construction means 21, a storage means 22, a reference means 23 and a liquidation processing means 24, by way of said database construction means 21 said data of whole customers being arranged for each of them so as to be stored in said storage means 22 as individual accumulated service points databases, on the basis of said databases as stored in said storage means 22 an accumulated service points data and a corresponding ordinal position of each customer being searchable through said reference means 23, through said liquidation processing means 24 larger accumulated service points data lined up to an ordinal position ‘n’ being extracted from said individual accumulated service points data bases and an amount of said accumulated service points corresponding to said ordinal position ‘n’ being defined as a liquidation point P, a consideration V according to said liquidation point P being given to higher-ranked customers lined up to said ordinal position ‘n’ so as to liquidate their accumulated service points, in which said accumulated service points of each customer less than said liquidation point P is carried over to a next term while said accumulated service points of each customer beyond said liquidation point P being carried over to said next term with said liquidation point P deducted from said accumulated service points so as to be stored in said storage means 22.

2. Service points liquidation system according to claim 1, wherein an amount of payment agreed upon in a commercial transaction executed on an internet homepage is converted into a service point by said conversion means 1, data on said service point being stored in said storage means 22.

3. Service points liquidation system according to claim 1, wherein one of a bus/taxi fare, a face value of a boarding ticket for traveling by transportation means such as air/ship/train and a traveled mileage is converted into a service point by said conversion means 1, data on said service point being stored in said storage means 22.

4. Service points liquidation system according to claim 1, wherein one of number of votes applied for and an amount paid to buy said votes by a customer in a speculative game that are found losers is converted into a service point by said conversion means 1, data on said service point being stored in said storage means 22.

5. Service points liquidation system according to claim 4, wherein a voting ticket discerning device 3 is provided to receive a magnetic voting ticket that a customer applies for, said voting ticket discerning device being provided with a discerning means 31 to check if said magnetic voting ticket is a winner or not and a disposal means 32 to collect and dispose of said voting ticket found a loser, wherein said votes cast in said voting ticket and found losers are converted into a service point by said conversion means 1 so as to be transmitted to said host computer 2.

6. Service points liquidation system according to claim 4, wherein said voting ticket is returned with only votes found losers processed when votes found winners are included in said voting ticket received in said voting ticket discerning device 3.

7. Service points liquidation system according to claim 4, wherein data on said votes cast by a customer through an electronic communication line to a host server and as such and found losers are transmittable to said host computer 2.

8. Service points liquidation system according to claim 1, wherein one of number of applications made and an amount paid by a customer for buying one of a tickets-enveloped lottery, a sealed lottery, a numbers choice lottery and a sports game result guessing lottery and as such that is found a loser is converted into a service point by said conversion means 1, data on said service point being stored in said storage means 22 of said host computer 2.

9. Service points liquidation system according to claim 8, wherein a service point is provided according to one of an amount paid and number of applications made for buying a lottery that is found a winner after an expiration of an effective term for money-exchange.

10. Service points liquidation system according to claim 8, wherein a lottery ticket discerning device 4 to receive a lottery ticket therein is provided, said device being provided with a discerning means 41 to check whether said lottery ticket is a winner or not and a disposal means 42 to collect and dispose of said lottery ticket that is found a loser, wherein one of an amount paid and number of applications for buying said lottery ticket that is found a loser is converted into a service point by said conversion means 1 so as to be transmitted to said host computer 2.

11. Service points liquidation system according to claim 1, wherein a service point is read out of and written in a data carrier D that each customer carries by means of a reader/writer 5, and data on said service point and an ID data on each customer are transmitted to said host computer 2 through said reader/writer 5.

12. Service points liquidation system according to claim 1, wherein said host computer 2 is provided with a data input means 25 to renew, rewrite and input said accumulated service points data as stored in said storage means 22.

13. Service points liquidation system according to claim 1, wherein said host computer 2 is provided with a buffer storage 26 to enhance data processing speed.

14. Service points liquidation system according to claim 1, wherein data on a specific ordinal position ‘m’ are extracted from said individual accumulated service points databases as stored in said storage means 22 by way of said liquidation processing means 24 and a prize is given to a customer ranked in said specific ordinal position ‘m’.

15. Service points liquidation system according to claim 1, wherein a plurality of host computers 2•2•• are connected to a governing server so that said service points are exchangeable among those computers.

16. Service points liquidation system according to claim 1, wherein said host computer 2 is connected to an internet server so that said accumulated service points data and corresponding ordinal position of each customer are searchable on an internet homepage.

17. Service points liquidation system according to claim 1, wherein a use of such portable data communication devices as a cellular phone enables said accumulated service points data and corresponding ordinal position of each customer as stored in said storage means 22 to be searched through a voice recording and push signals.

18. Service points liquidation system according to claim 1, wherein only data on a searcher and higher-ranked customers are searchable from said individual accumulated service points databases.

19. Service points liquidation system according to claim 1, wherein said accumulated service points data and corresponding ordinal position of each customer are electronically and automatically mailed on a periodical or non-periodical basis to a customer address as preliminarily registered.

20. Service points liquidation system according to claim 1, wherein a customer whose accumulated service points are subjected to liquidation is also registered in a host computer 2 defined as a one-rank superior system.

21. Service points liquidation system according to claim 2, wherein one of a bus/taxi fare, a face value of a boarding ticket for traveling by transportation means such as air/ship/train and a traveled mileage is converted into a service point by said conversion means 1, data on said service point being stored in said storage means 22.

22. Service points liquidation system according to claim 5, wherein said voting ticket is returned with only votes found losers processed when votes found winners are included in said voting ticket received in said voting ticket discerning device 3.

23. Service points liquidation system according to claim 5, wherein data on said votes cast by a customer through an electronic communication line to a host server and as such and found losers are transmittable to said host computer 2.

24. Service points liquidation system according to claim 6, wherein data on said votes cast by a customer through an electronic communication line to a host server and as such and found losers are transmittable to said host computer 2.

25. Service points liquidation system according to claim 9, wherein a lottery ticket discerning device 4 to receive a lottery ticket therein is provided, said device being provided with a discerning means 41 to check whether said lottery ticket is a winner or not and a disposal means 42 to collect and dispose of said lottery ticket that is found a loser, wherein one of an amount paid and number of applications for buying said lottery ticket that is found a loser is converted into a service point by said conversion means 1 so as to be transmitted to said host computer 2.
